(19) United States
(12) Patent Application Publication
(10) Pub. No.: US 2008/0084494 A1
(43) Pub. Date: Apr. 10, 2008

(54) Ribbon cassette for mailing machine

(75) Inventor: John A. Pomfret, East Lyme, CT (US)

Correspondence Address: IRA S. DORMAN, 330 ROBERTS STREET, SUITE 200, EAST HARTFORD, CT, 06108, US

(73) Assignee: Cartec International, Inc.

(21) Appl. No.: 11/702,709

(22) Filed: Feb. 6, 2007

Related U.S. Application Data
(63) Continuation-in-part of application No. 11/388,167, filed on Mar. 23, 2006.

(51) Int. Cl. H04N 5/232; G03B 13/00

(52) U.S. Cl. 348/345

(57) ABSTRACT

A thermal ink ribbon cassette for a mailing machine has an anti-reverse leaf spring for preventing rotation of the take-up spindle in the unwinding direction, and a member that serves to limit deflection of the spring produced by engagement with teeth that surround the spindle base.

### CROSS REFERENCE TO RELATED APPLICATION

This is a continuation-in-part of copending application Ser. No. 11/388,167 filed Jan. 24, 2006, the entire specification of which is incorporated hereinto by reference thereto.

### BACKGROUND OF THE INVENTION

Mailing machines are of course in common use for applying postage to envelopes. Such machines now typically employ a thermal ink ribbon, comprised of a thin plastic film coated with a fusible layer comprising an ink composition, which composition is transferred, in selected patterns for printing postage and graphics, to an envelope passed in contact therewith under a thermal print head of the machine.

U.S. Pat. No. 5,959,652 provides a concise description of such a mailing machine and a thermal ink ribbon cassette suitable for use therein. The disclosure of that patent, at lines 13 through 49 in column 1 and at line 32 of column 5 to line 58 of column 6, together with FIG. 1, is hereby incorporated hereinto by reference thereto. The following United States Patents are also of interest to the present invention: U.S. Pat. Nos. 4,908,632; 5,192,149; 5,392,148; 5,529,410; 5,619,244; 5,917,532; 5,933,179; and 6,301,522.

Despite the extensive efforts that have been devoted to the development of thermal ink ribbon cassettes for mailing machines, of which the foregoing prior art is indicative, improvements in the design and construction of such cassettes would of course be desirable. In particular, although the need for establishing and maintaining a proper tension upon the ink ribbon has been well recognized and addressed, it is not believed that optimal means for doing so has heretofore been provided. Moreover, while suitable anti-reverse mechanisms are known for preventing unwinding of the used ribbon from the take-up spindle, in their present forms such mechanisms tend to be unduly noisy, complex, difficult to assemble, and not entirely effective.

### SUMMARY OF THE INVENTION

Accordingly, it is the broad object of the present invention to provide a novel ink ribbon cassette, especially for a mailing machine and in particular a thermal ink ribbon cassette, which avoids at least certain disadvantageous features of the cassettes known in the art and currently commercially available.

More specific objects of the invention are to provide such an ink ribbon cassette in which tension control and anti-reverse functions are achieved by means that are highly effective and yet relatively uncomplicated, in which the level of noise produced during advance and tightening of the ribbon is low, and in which assembly is facilitated and performance may be optimized.

It has now been found that certain of the foregoing and related objects of the invention are attained by the provision of an ink ribbon cassette comprised of a housing, ribbon supply means, a ribbon take-up spindle, an anti-reverse leaf spring, and spring deflection-limiting means, which cassette may additionally include a constant-tension drag arrangement, a ribbon guide bar, and an ink ribbon supply. The housing of the cassette will normally be comprised of an assembled base component and mating cover component, secured to one another and defining an interior space therewithin. The base component comprises a back wall, which faces rearwardly in the normal orientation of the ribbon cassette in a mailing machine, and the cover component comprises a front wall which faces forwardly in such normal orientation, the front and back walls usually being of generally planar form. At least one of the housing components provides a peripheral wall, which may comprise an upper portion, a transversely spaced lower portion, and laterally spaced opposite end portions. The lower portion of the peripheral wall may be formed with an upwardly extending recess for receiving the print head assembly (i.e., the print head and the mounting bracket) of a mailing machine, the recess being defined by an upper wall section and first and second lateral wall sections, spaced laterally from one another. The lower portion of the peripheral wall will have an exit opening, which may be adjacent to and upstream of the first lateral wall section, and it will have an entrance opening, which may be adjacent to and downstream of a second lateral wall section, the upstream and downstream references being expressed with respect to the direction of ribbon travel from the supply side to the take-up side of the cassette.

The ribbon take-up spindle is rotatably mounted upon the base component of the housing, within the interior space and on the take-up side of the cassette; the ribbon supply means may comprise a similar spindle, rotatably mounted on the supply side. Each of the spindles (or at least the take-up spindle) comprises a circular base having an array of teeth extending about its circumference, and a center shaft extending substantially normal to the base for supporting a roll of fresh or used printing ribbon, as the case may be.

The anti-reverse spring is mounted upon the housing and has an outer end portion in engagement with the teeth of the take-up spindle. The spring is so configured and disposed as to permit rotation of the take-up spindle in its forward, ribbon-winding direction while preventing rotation in the reverse, ribbon-unwinding direction thereof.

More particularly, the anti-reverse leaf spring comprises a fixed end portion mounted upon the housing, a free opposite end portion, and an intermediate, elastically deflectable portion therebetween. The spring is so configured and disposed that its intermediate portion urges the free opposite end portion into substantially constant engagement with the array of teeth on the base of the take-up spindle, and it coacts with the teeth so as to permit or prevent rotation, as described. That is, during rotation of the spindle in the forward direction the teeth will deflect the spring and will readily pass under its free end portion; if force is applied to rotate the spindle in the reverse direction, however, the end of the terminal portion will jam against the face of a tooth, and thereby prevent movement.

Fresh rolls of printing ribbon will usually be supported on a supply spindle in fixed relationship and with an end portion of the ribbon attached thereto. The ribbon will travel along a path from the supply spindle, outwardly of the housing through the exit opening, back into the housing through the entrance opening, and then to the take-up spindle for winding thereupon.

The noise-reduction feature of the present cassette (as well as other advantageous characteristics) is achieved by the provision of a deflection-limiting member on the cassette housing. In its broad form the deflection-limiting member comprises a fixed element that is so disposed as to engage the leaf spring and thereby limit the extent to which it is deflected by the teeth of the rotating take-up spindle.

More specifically, the fixed element of the deflection-limiting member will usually comprise a first wall element, disposed to engage a confronting face of the intermediate portion of the leaf spring. A fixed, second wall element will desirably cooperate with the first wall element to define a slot (normally, an open-ended slot) in which the leaf spring intermediate portion is deflectably received, the second wall element being so disposed as to engage a confronting, opposite face of the intermediate portion of the leaf spring; a transverse surface, lying between the first and second wall elements, may define a closed end of the slot on which the leaf spring is supported. The deflection-limiting member will advantageously comprise a post having a free end portion into which a slot is formed, the post projecting forwardly from the back wall of the base component and the free end portion being at the forward end of the post. In most instances the teeth on the base of the take-up spindle will extend radially outwardly, and the fixed element (e.g., the “first” wall element) of the deflection-limiting member will therefore limit outward deflection.

The housing of the cassette will usually comprise mounting structure for disengageably receiving the fixed end portion of the anti-reverse leaf spring adjacent the peripheral wall. One of the housing components will advantageously be formed with such mounting structure (e.g., defining a slot), with the other component providing means for maintaining the assembly. Interengageable elements will desirably be provided for preventing inadvertent endwise displacement of the fixed end portion of the leaf spring within the receiving slot.

The anti-reverse leaf spring may more specifically comprise a normally rectilinear mounting leg, providing the fixed end portion, a normally rectilinear intermediate leg disposed at a first obtuse angle to the mounting leg and providing the intermediate portion, and a terminal contact element disposed at a second obtuse angle to the intermediate leg and providing the free opposite end portion, the first and second obtuse angles being taken with respect to a common side of the spring. The spring will usually be fabricated from a strip of spring steel, which will typically be about 7 to 8 miles thick and about 0.3 inches wide; the mounting leg will typically be about 0.6 inch long, the intermediate leg will typically be about 0.3 inch long, and the terminal element will typically be about 0.09 inch long; the “first” obtuse angle will typically have a value of 110° to 116° and the “second” obtuse angle will typically have a value of 132° to 138°.

### BRIEF DESCRIPTION OF THE DRAWINGS

FIG. 1 is a perspective view of an ink ribbon cassette of a kind to which the present invention is directed;

FIG. 2 is a plan view of the cassette of FIG. 1, showing internal features in dotted line;

FIG. 3 is an exploded perspective view depicting the cassette of the foregoing figures;

FIG. 4 is a fragmentary plan view of the cassette, in partial section, with portions of the cover component and the ribbon spindles broken away;

FIG. 5 is a fragmentary sectional view, taken along line 5-5 in FIG. 4 and drawn to an enlarged scale, showing the stub axle and the spur gear rotatably mounted thereupon, and the expansion rod positioned for entry thereinto;

FIG. 6 is a plan view of the spur gear depicted in FIGS. 4 and 5, drawn to a further enlarged scale;

FIG. 7 is a sectional view of the spur gear, taken along line 7-7 in FIG. 6;

FIG. 8 is a plan view of the ink ribbon supply spindle utilized in the cassette;

FIG. 9 is bottom view of the supply spindle;

FIG. 10 is an elevational view of the supply spindle, shown in partial section taken along line 10-10 in FIG. 9;

FIG. 11 is an end view of the core upon which a fresh roll of ink ribbon is wound, for mounting upon the supply spindle;

FIG. 12 is a sectional view of the core of FIG. 11, taken along line 12-12 therein and drawn to an enlarged scale;

FIG. 13 is a plan view of the take-up spindle utilized in the cassette;

FIG. 14 is a bottom view of the take-up spindle;

FIG. 15 is an elevational view of the take-up spindle, in partial section;

FIG. 16 is an edge view of the anti-reverse leaf spring utilized in the cassette, as shown in FIGS. 1-4, 18 and 22;

FIG. 17 is an elevational view of the anti-reverse leaf spring;

FIG. 18 is a fragmentary elevational view, taken along line 18-18 in FIG. 4, showing the anti-reverse leaf spring in engagement with an upper zone of the array of teeth on the base of the take-up spindle, and showing the drive gear of a mailing machine in meshing engagement with a lower zone of the array of teeth.

FIG. 19 is a fragmentary plan view of the base component of a preferred form of ink ribbon cassettes embodying the present invention;

FIG. 20 is a fragmentary sectional view taken along line 20-20 in FIG. 19 and drawn to an enlarged scale;

FIG. 21 is a fragmentary sectional view taken along line 21-21 in FIG. 19 and drawn to an enlarged scale; and

FIG. 22 is a fragmentary perspective view showing a portion of the cassette illustrated in FIG. 19, drawn to a further enlarged scale and having the anti-reverse leaf spring assembled therewith.

### DETAILED DESCRIPTION OF THE ILLUSTRATED EMBODIMENTS

Turning now in detail to the appended drawings, therein illustrated is an ink ribbon cassette, for a mailing machine, including a housing comprised of a base component, generally designated by the numeral 10, and a cover component generally designated by the numeral 12. Both components of the housing are integrally formed, each as a single piece, such as by molding of a suitable thermoplastic or thermosetting synthetic resinous material (e.g., an ABS plastic).

As mounted in its normal operating orientation in a mailing machine, the base component 10 provides the back wall 14 of the cassette and the cover component 12 provides the front wall 16 thereof. A peripheral wall, generally designated by the numeral 18, extends about the front wall 16 and is integrally formed therewith as a portion of the cover component 12; it will be self-evident however that the peripheral wall may be formed with the base component or, indeed, that elements forming the peripheral wall may be provided cooperatively by both components of the housing. Several pins 20 project normal (i.e., forwardly) from the raised edge 22 that surrounds the back wall 14, and are engaged in corresponding holes 24 formed into the confronting edge of the peripheral wall 18, thereby serving to secure the base and cover components 10, 12 in assembly, which together thereby define an interior space 26 within the housing.

A pair of circular recesses 28, 30 are molded into the back wall 14 of the base 10 on the supply side and the take-up side of the cassette, respectively, as is a short interconnecting channel 32. An elevated circular platform 34, with a forwardly projecting central hub element 36, is concentrically formed within the recess 28 and serves to rotatably support a ribbon supply spindle, generally designated by the numeral 58. A pair of openings 38, 40 extend through the back wall 14 of the base component 10 and serve to receive elements of the optical sensing system that is provided in the mailing machine.

A cylindrical hub element 42 projects forwardly and concentrically within the take-up side recess 30, and serves to rotatably support a take-up spindle, generally designated by the numeral 72. A circular aperture 44 is provided in the back wall 14 and serves to receive the ribbon-transport drive gear 156, best seen in FIG. 4 of the drawings and which is driven by the mailing machine motor (not illustrated).

An axially split stub axle element, generally designated by the numeral 46, projects forwardly from the back wall 14 within the connecting channel 32. A finger element 48, joined at one end to the channel-defining structure of the base component 10, extends laterally along the channel 32 and defines an open-ended slot 50. Short tabs 52, 54 project forwardly, at spaced locations along the raised edge 22 of the base, and another short tab 56 extends laterally therefrom; tabs 52, 54 facilitate registry and assembly of the base component 10 with the cover component 12; tab 56 cooperates with the mailing machine for mounting purposes.

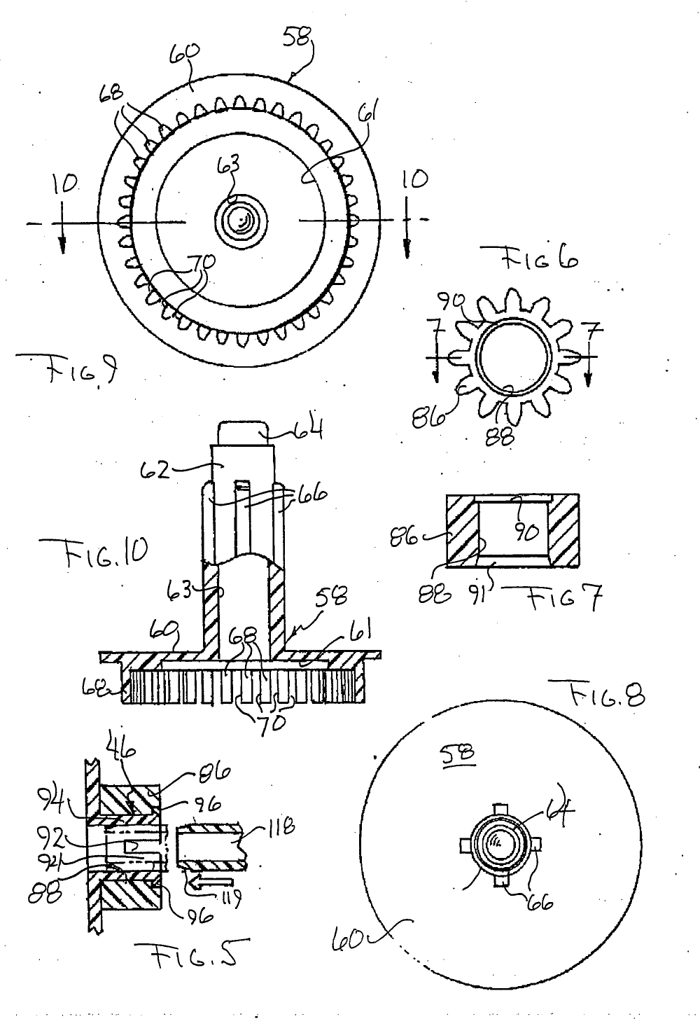

As is best seen in FIGS. 8-10, the supply spindle 58 consists of a circular base portion 60, from which extends a central shaft portion 62 having a forward end element 64 of reduced diameter; four splines 66 extend axially along the shaft portion 62 at equiangularly spaced locations. A shallow circular recess 61, formed into underside of the base portion 60, communicates with the bore 63 that extends forwardly into the shaft portion 62; as will be appreciated, the recess 61 receives the elevated platform 34 on the back wall 14 and the bore 63 receives the central hub element 36 thereon, to rotatably mount the supply spindle 58 on the base component 10.

A cylindrical skirt extends downwardly (rearwardly) from the underside of the circular base portion 60, and provides a circumferential array of gear teeth 68 with intervening gaps 70. In addition to serving a mechanical function (described below), the gear teeth 68 and (more particularly) the gaps 70 serve to regularly interrupt the light beam generated by the optical sensor system of the mailing machine, thereby generating a supply spindle rotation rate-dependent pulse for controlling movement of the printing ribbon through the cassette, and hence through the mailing machine.

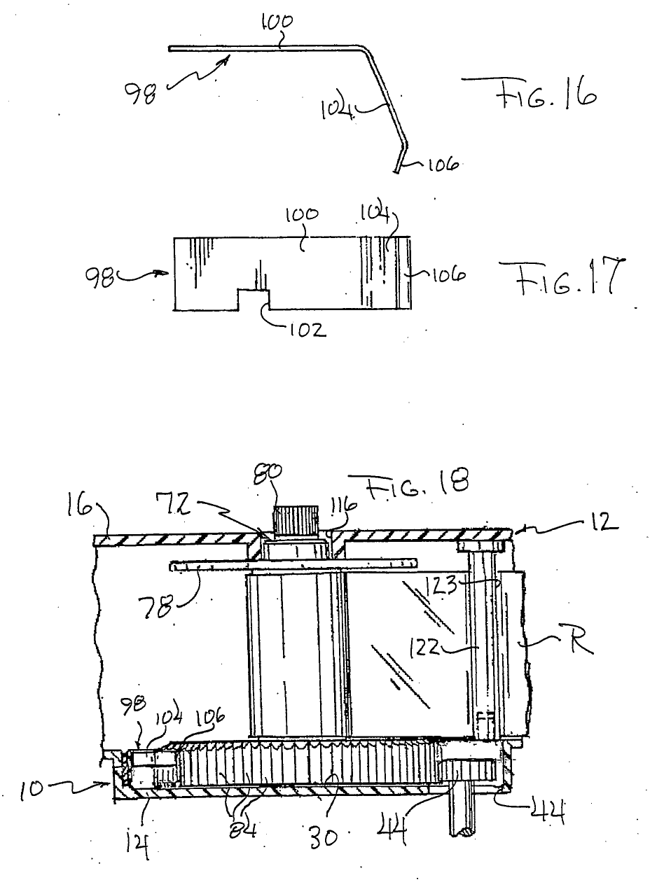

The take-up spindle 72 is most fully illustrated in FIGS. 13-15 and, like the supply spindle 58, consists of a circular base portion 74 having an upstanding hollow central shaft portion 76 extending forwardly therefrom, on an axis normal to the plane of the base portion 74, and a depending circumferential skirt portion 82 extending thereabout. A disk element 78 is formed near the forward end of the shaft portion 76, and a knurled knob element 80 projects coaxially therefrom (to permit facile manual rotation of the take-up spindle). The lower end of the shaft portion 76 is open, for rotatably mounting the spindle 72 with the cylindrical collar portion 42 on the back wall 14 of the base 10 received in the bore 77; an array of radially extending gear teeth 84, formed on the exterior of the depending skirt portion 82, surrounds the base portion 74 of the spindle. Needless to say, both spindles 58, 72 will normally be molded from a suitable synthetic resinous material

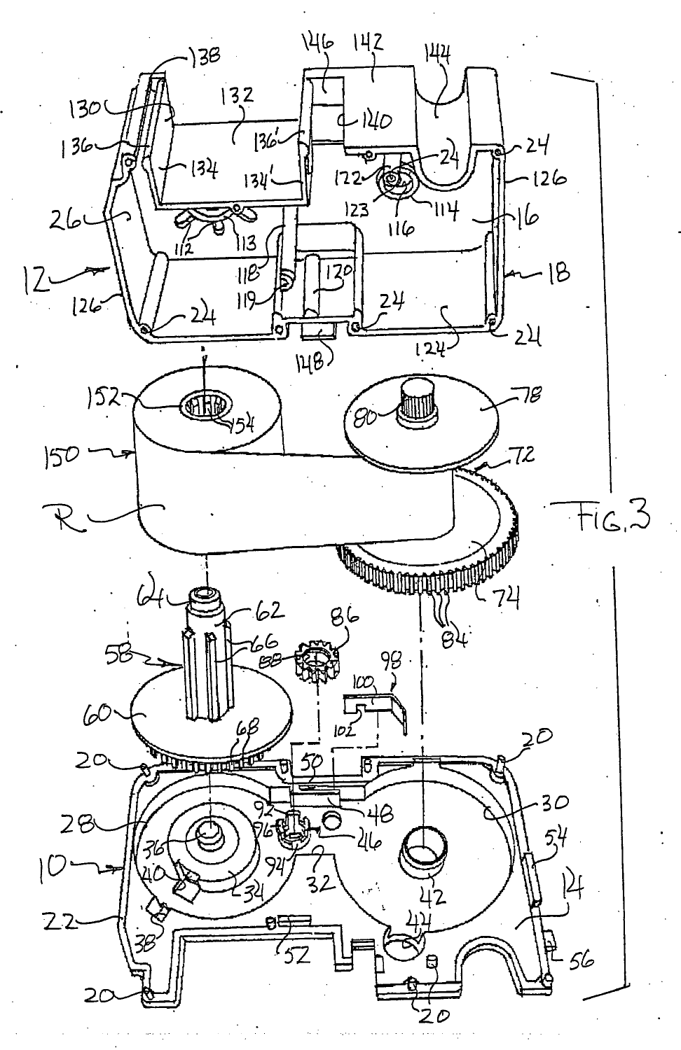

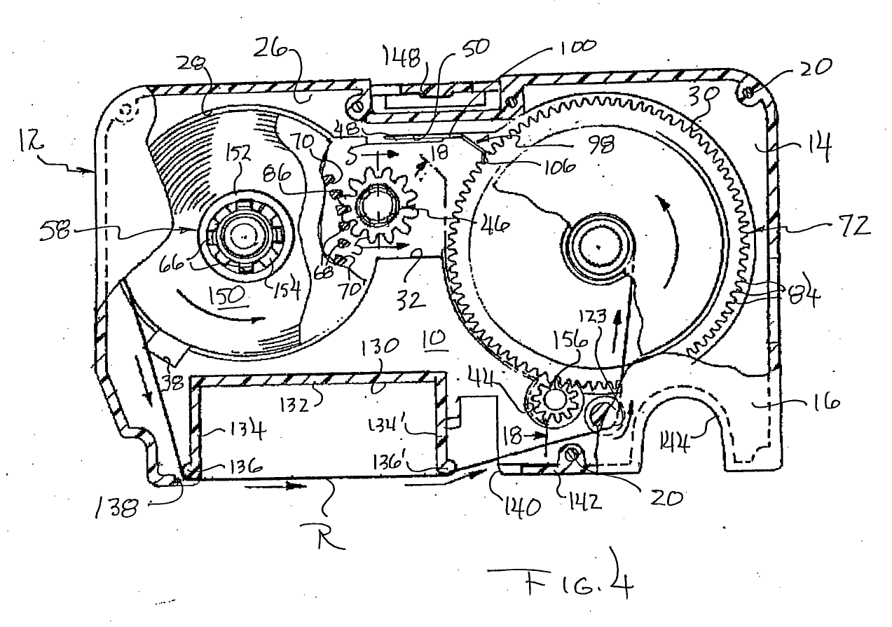

As is best seen in FIGS. 3-7, a spur gear 86 is rotatably mounted upon the stub axle 46, which extends through its axial aperture 88. The aperture 88 is enlarged adjacent at its forward (upper) end, to provide a circumferential shoulder 90, and it has a tapered lead-in section 91 at its rearward (lower) end. The structure forming the stub axle 46 is axially slotted downwardly, from its upper end, at each of four equiangularly spaced locations 92 so as to form four expansion sections 94 which are resiliently deflectable in radial directions. The outwardly deflected sections 94 effectively expand the axle 46 circumferentially, engaging the inside surface of the gear 86 defining the axial aperture 88 and thereby producing a drag force of constant magnitude thereon; the spur gear 86 is freely rotatable upon the stub axle 46 when the sections 94 are in a non-deflected, relaxed condition. As will be appreciated, the lead-in taper 91 facilitates assembly of the spur gear 86 upon the stub axle 46, and the shoulder 90 serves to seat the lip elements 96, formed on the free outer ends of the axle sections 94, to thereby lock the gear 86 against disassembly from the stub axle 46.

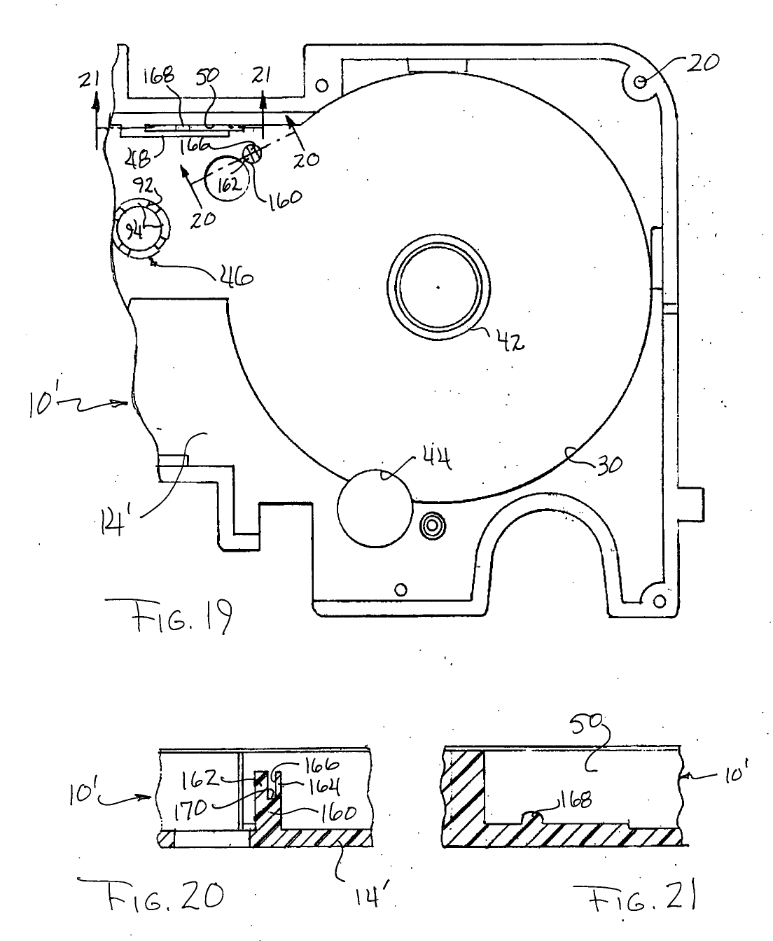

Turning now in greater detail to FIGS. 16 and 17, the anti-reverse leaf spring employed, generally designated by the numeral 98, will normally be made of spring steel and is seen to comprise a mounting leg 100 having a notch 102 formed into one edge, an intermediate leg 104 disposed at an obtuse angle to the leg 100, and a terminal contact element 106 disposed at an obtuse angle to the leg 104. As indicated in FIG. 3, and depicted in FIG. 4 (and in FIG. 22, discussed below), the mounting leg 100 of the spring 98 is seated within the slot 50 formed behind the finger 48; the leg 104 extends from the slot 50, and positions the element 106 in engagement with the array of gear teeth 84 surrounding the base 78 of the take-up spindle 72. Although not visible in FIG. 3 (but described below), a small protrusion extends upwardly into the slot 50, from the back wall 14 of the housing base, and engages in the notch 102 in the leg 100 so as to prevent inadvertent lateral displacement of the spring 98 from the slot; an element (also described below) on the cover component 12 serves to hold the leaf spring 98 against upward displacement. As is shown in FIG. 18, the leaf spring 98 bears upon an upper zone (taken with reference to a transaxial plane through the skirt portion 82) of the circumferential array of gear teeth 84 on the take-up spindle 72.

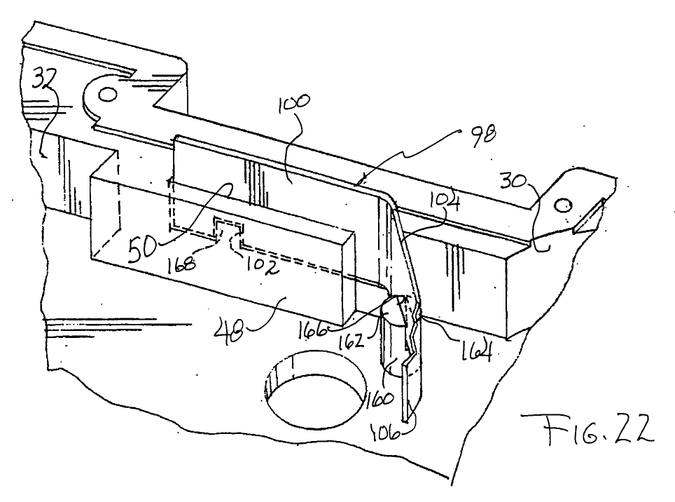

FIGS. 19, 20 and 22 show a spring deflection-limiting post 160, which is integrally formed on the back wall 14′ of the base member 10′ of the illustrated cassette, embodying the present invention. It will be appreciated that the post 160 is an augmentation of the cassettes hereinbefore and hereinafter described. A relatively thick outer wall element 162 and a relatively thin inner wall element 164 define a slot 166 that extends downwardly (rearwardly) into the free (forward) end portion of the post 160, the bottom of which slot 166 is defined by a transverse surface 170.

As seen in FIG. 22, the intermediate leg 104 of the anti-reverse leaf spring 98 is received in the slot 166 of the post 160. The outer wall element 162 of the post serves to limit outward deflection of the leg 104, (i.e., deflection away from the axis of the take-up spindle 72), produced by contact of the terminal spring element 106 with the apex portion of each of the teeth 84 of the circumferential array, passing thereunder as the spindle 72 rotates. The element 162 is made relatively thick so as to enable it to withstand the forces that are generated by the spindle teeth and transmitted thereto by the spring 98.

It will be appreciated that it is the elastic return of the terminal contact element 106 from its fully deflected position, and the resultant impact upon the surfaces of the teeth 84 adjacent their apices, which cause the rapid clacking or ratcheting sound that occurs during manual or automatic advance of the printing ribbon in a cassette that employs such an anti-reverse leaf spring. The provision of a deflection limiting feature, in accordance with the present invention, has been found to greatly abate the noise produced and thereby to cause the cassette to operate much more quietly and in a much more desirable manner than would otherwise be the case.

The inner wall element 164 of the post 160 also contributes to the noise-abatement effect, by limiting inward movement of the anti-reverse spring. By cooperatively defining the slot 166, moreover, the wall 164 contributes to the stable positioning of the spring and ensures that the legs and contact element thereof will be disposed at optimal angles to one another (typical values of which are hereinabove set forth) and to the take-up spindle tooth array, irrespective of whether the spring itself has been optimally formed or has, indeed, been distorted.

It should be noted that, while the slot 166 should be sufficiently narrow to adequately constrain the leg 104, it should not be so narrow as to prevent such deflection as is necessary for the spring to perform its intended function. When for example the spring is about 7 to 8 mils thick (as it will typically be in preferred embodiments of the invention), a slot that is about 44 mils wide has been found to afford optimal functionality. It is also noted that the spring referred to was about 0.23 inch wide, the legs 100, 104 were about 0.61 and 0.33 inch long, respectively, and disposed at an angle of about 110° to 116° to one another, and the terminal element 106 was about 0.1 inch long and disposed at an angle of about 132° to 138° to the leg 104.

As is seen in FIGS. 21 and 22, a small protrusion or bump 168 projects upwardly from the wall 14′ into the slot 50, formed behind the finger 48 at the periphery of the cassette, and is engaged within the notch 102 in the leg 100 of the spring 98. Under downward force, applied by the half-round rib 120 that is located on the peripheral wall 18 of the cover component 12 (as described more fully below), the protrusion 168 prevents inadvertent lateral displacement of the spring 98 within and from the slot 50. The transverse surface 170, at the bottom of the slot 166 in the post 160, engages and provides underlying support for the leaf spring 98, preventing tipping and thereby contributing to its stable positioning, as may be especially helpful during assembly.

With further reference to the cover component 12 of the cassette housing, the front wall 16 has a circular hole 110 formed therethrough, concentric with which are an arrangement of radially extending oval slots 112 (which serve to enable visual inspection of the remaining supply of fresh ribbon) and a rearwardly projecting hold-down ring structure 113 (for stabilizing the supply spindle 58). A ring clement 114 is similarly provided on the take-up side of the cassette, and is disposed coaxially with the circular hole 116 for stabilizing the take-up spindle 72.

Also depending from the front wall 16 of the cover component 12 is an expansion rod 118, which is of generally cylindrical cross section but is relieved along one side to provide clearance for the spindle 58; the free end 119 of the rod 118 is tapered. As will be evident, when the cover and base components of the housing are assembled the rod 118 is inserted into the bore of the stub axle 46, thereby deflecting outwardly the sections 94 and creating a drag force on the spur gear 86, as previously described. Because the rod 118 is relieved along one side, it will generally deflect only three of the sections 94; the resulting increase in effective cross section will nevertheless produce the desired frictional drag force upon the spur gear.

As previously mentioned, the half-round rib 120 extends transversely along the inside surface of wall structure comprising the upper portion 124 of the peripheral wall 18, and provides the element for retaining the leaf-spring 98 in the slot 50 against inadvertent upward displacement, it being evident that the flat rearward end of the rib 120 overlies the leg 100. A hole 24 extends into the free end of the depending cylindrical guide bar 122 for engaging an aligned fastening pin 20 formed on the back wall 14 of the base component 10.

The peripheral wall 18, integrally formed on the cover component 12, comprises an upper portion 124 and opposite end portions 126. The lower portion of the peripheral wall 18 is formed with a rectangular recess 130, which serves to receive the print head and the head-mounting bracket of a printing (e.g., mailing) machine. The recess 130 is defined by an upper wall section 132 and two laterally spaced lateral wall sections 134, 134′, each of which terminates as a smoothly rounded lower free edge element 136, 136′. The edge element 136 on the upstream side of the cassette (taken with reference to the direction of ribbon movement) cooperates with the closely adjacent peripheral wall structure to define a narrow exit slot 138; the edge element 136′ on the downstream side is spaced substantially from the adjacent peripheral wall section 142 (which is flat, and substantially parallel to the upper wall section 132 and the upper wall portion 124) so as to define a relatively wide entrance gap or opening 140. It should be appreciated that the two lateral wall sections 134, 134′ are of virtually the same transverse length, sufficient to ensure slight spacing between the length of printing ribbon that spans the recess 130 and the print head and mounting bracket seated therein.

The flat wall section 142 of the peripheral wall joins a semi-circular section 144, which defines an indentation into the lower portion of the housing for receiving the envelope-drive roller of the mailing machine. As is also conventional in cassettes of the present kind, latching structure 148 is formed on the upper portion 124 of the peripheral wall 18 and serves to disengagably secure the cassette in operative position within the cavity provided in the mailing machine.

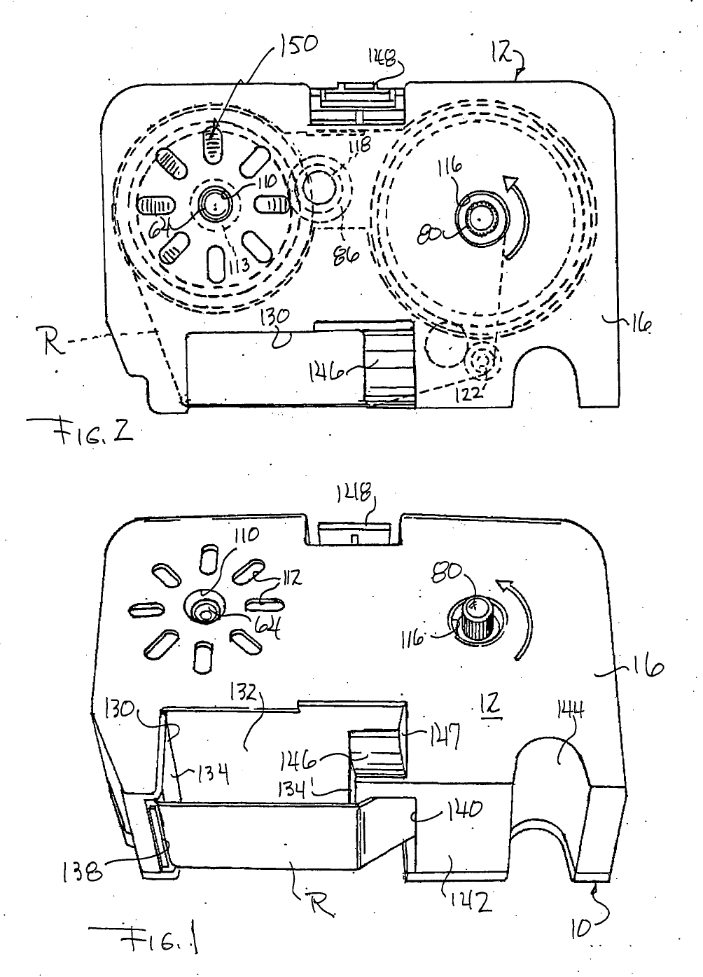

As is best seen in FIGS. 1 and 2, a curved wall section 146 extends inwardly from the front wall 16 of the cassette, adjacent the straight wall section 142 and toward the upper peripheral wall portion 124. The curved wall section 146 cooperates with the laterally offset wall segment 147 to provide a “thumb-print” area for gripping of the cassette to facilitate insertion into and removal from the mailing machine. It will be appreciated that the curved wall section 146 and the laterally offset segment 147 of the wall section 134′ extend into the space 26 within the housing.

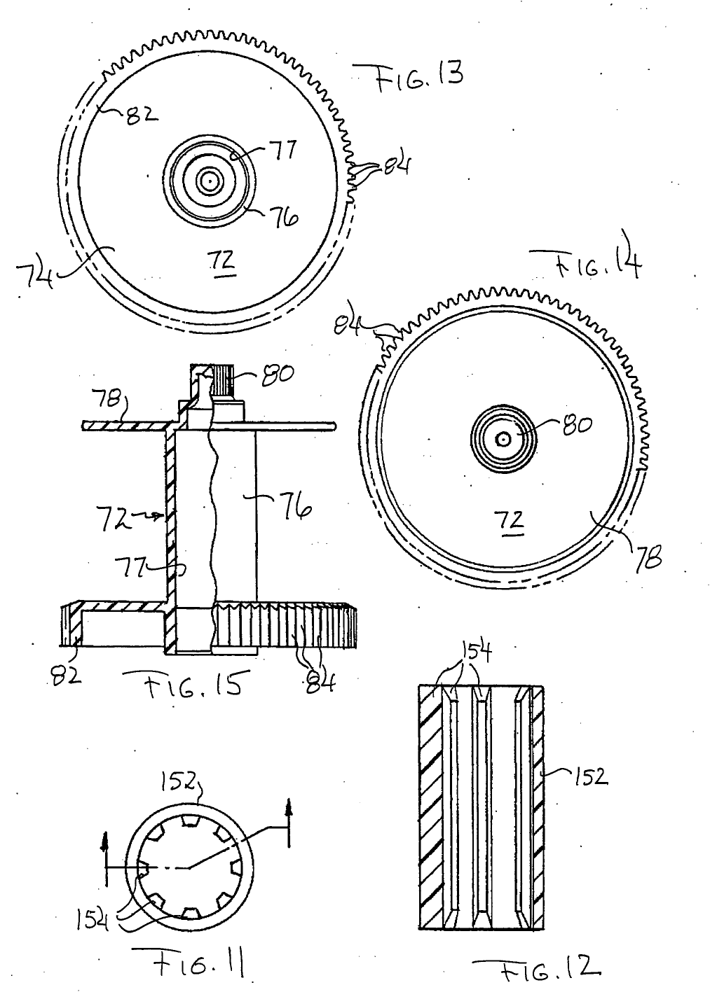

The ribbon “R” is supplied as a so-called “pancake,” generally designated by the numeral 150, which includes the cylindrical core 152 on which the ribbon is wound. As seen in FIGS. 11 and 12, the core 152 is formed with eight internal ribs 154, extending axially along its bore, which ribs 154 cooperate with the splines 66 on the shaft 62 of the spindle 58 to mount the ribbon pancake 150 thereupon for rotation therewith.

As best seen in FIG. 4, the drive gear 156 of a mailing machine protrudes through the opening 44 in the back wall 14 of the cassette base component 10 and is disposed in meshing engagement with the circumferential array of gear teeth 84 on the base portion 74 of the take-up spindle 72. As depicted in FIG. 18, engagement of the drive gear 156 occurs at a lower zone of the array of gear teeth 84 (taken with reference to a transaxial plane through the skirt portion 82), and consequently any wear that might be caused by the steel anti-reverse spring 98, which engages only the upper zone of the gear teeth array, will not affect the ability of the gear 156 to effectively drive the take-up spindle and, in turn, to advance the ribbon R through the cassette.

FIGS. 2 and 4 best indicate the travel path of the ribbon R through the cassette, with the arrows in FIG. 4 showing the direction of ribbon movement as well as the counterclockwise direction of pay-off from the spindle 58 and take-up upon the spindle 72. As is best seen in FIGS. 3 and 4, after spanning the print head-receiving recess 130 the ribbon R enters the opening 140 and passes about the curved surface 123 of the guide bar 122 before winding upon the take-up spindle 72. Not only does the guide bar serve to displace the ribbon R, so as to avoid interference with the thumb-print structure 146, 147, but it also cooperates to produce a desired level of tension on the ribbon (due in part to wrapping about a small radius member, which typically has a value of 1/16 to ¼, and preferably ⅛ inch) and a desired take-up attack angle, while maintaining it in a smooth, unwrinkled condition, preventing its wandering, and improving its tracking.

It will be appreciated that many variations can be made in the cassette of the invention without departing from the novel concepts defined. For example, while the cassettes illustrated and described in detail herein are made for use in a mailing machine, for printing postage, their unique features may be incorporated into cassettes of analogous, but different, construction, suitable for use in a variety of printing applications. Also, while the anti-reverse leaf spring hereinabove described functions against teeth that extend radially outwardly on the take-up spindle, the leaf spring may instead be disposed internally of the spindle base, to act against radially inwardly extending teeth (or functionally equivalent elements).

Thus, is can be seen that the present invention provides a novel ink ribbon cassette that avoids at least certain disadvantageous features of cassettes known in the art and currently commercially available. Tension control and anti-reverse functions are achieved by means that are highly effective and yet relatively uncomplicated; the level of noise produced during advance and tightening of the ribbon is low, assembly is facilitated, and performance may be optimized.

Having thus described the invention, what is claimed is:

1. A ribbon cassette for a printing machine, said cassette having laterally adjacent ribbon supply and ribbon take-up sides, and including:
a housing having an interior space therewithin and being comprised of at least a base component and a cover component, and having a peripheral wall extending thereabout, said base component comprising a back wall, said cover component comprising a front wall, and said peripheral wall having an exit opening and an entrance opening therein, from and to said interior space;
means for supporting a roll of fresh printing ribbon and a roll of used printing ribbon within said interior housing space on said supply side and said take-up side of said cassette, respectively, said means for supporting comprising a take-up spindle, for used printing ribbon, rotatably mounted upon said base component on said take-up side of said cassette and comprising a circular base having an array of teeth extending about the circumference thereof;
an anti-reverse leaf spring comprising a fixed end portion, mounted upon said housing, a free opposite end portion, and an intermediate, elastically deflectable portion therebetween, said anti-reverse spring being so configured and disposed that said intermediate portion urges said free opposite end portion thereof into substantially constant engagement with said array of teeth on said base of said take-up spindle, and said leaf spring coacting with said teeth so as to permit rotation of said take-up spindle in a forward, ribbon-winding direction of said take-up spindle while preventing rotation of said take-up spindle in the reverse, ribbon-unwinding direction thereof;
a roll of printing ribbon supported for unwinding by said means for supporting on said supply side of said cassette and traveling therefrom along a path that passes outwardly of said housing through said exit opening, back into said housing through said entrance opening, and to said take-up spindle for winding thereupon; and
a deflection-limiting member on said housing comprised of a fixed element that is so disposed as to engage said leaf spring and to thereby limit the extent to which said leaf spring intermediate portion is deflected due to engagement of said free end portion thereof with said array of teeth during rotation of said take-up spindle.

2. The cassette of claim 1 wherein said fixed element is a first wall element disposed to engage a confronting face of said intermediate portion of said leaf spring.

3. The cassette of claim 1 wherein said deflection-limiting member further comprises a fixed, second wall element that defines, in cooperation with said first wall element, a slot in which said leaf spring intermediate portion is deflectably received, said second wall element being so disposed as to engage a confronting, opposite face of said intermediate portion of said leaf spring and to thereby limit movement thereof.

4. The cassette of claim 3 wherein said deflection-limiting member has a transverse surface that extends between said first and second wall elements, at a closed end of said slot, and that supports said leaf spring intermediate portion thereupon.

5. The cassette of claim 4 wherein said deflection limiting member comprises post having a free end portion in which said slot is formed.

6. The cassette of claim 5 wherein said post projects forwardly from said back wall of said base component, wherein said free end portion is at the forward end of said post, and wherein said slot is open ended and extends rearwardly from said forward end of said post.

7. The cassette of claim 1 wherein said teeth of said array on said base of said take-up spindle extend radially outwardly therefrom, and wherein said fixed element limits the extent to which said leaf spring intermediate portion is deflected outwardly.

8. The cassette of claim 7 wherein said array of gear teeth on said base of said take-up spindle has an upper zone and a lower zone, defined by a transaxial plane, and wherein said engagement of said outer end portion of said anti-reverse spring is limited substantially to said upper zone of said array.

9. The cassette of claim 1 wherein said housing comprises mounting structure for disengageably receiving said fixed end portion of said anti-reverse leaf spring adjacent said peripheral wall.

10. The cassette of claim 9 wherein one of said housing components is formed with said mounting structure and the other of said housing components is formed with means for maintaining said fixed end portion of said leaf spring in assembly with said mounting structure.

11. The cassette of claim 10 wherein said mounting structure defines a slot in which said fixed end portion of said leaf spring is received, and wherein said mounting structure and said fixed end portion of said leaf spring have interengageable elements thereon for preventing inadvertent endwise displacement of said fixed end portion of said leaf spring within said receiving slot.

12. The cassette of claim 1 wherein said anti-reverse leaf spring comprises a normally rectilinear mounting leg, providing said fixed end portion, a normally rectilinear intermediate leg disposed at a first obtuse angle to said mounting leg and providing said intermediate portion, and a terminal contact element disposed at a second obtuse angle to said intermediate leg and providing said free opposite end portion, said first and second obtuse angles being taken with respect to a common side of said leaf spring.

13. The cassette of claim 12 wherein, at least in assembly with said deflection-limiting member, said first obtuse angle has a value of 110° to 116° and said second obtuse angle has a value of 132° to 138°.

14. The cassette of claim 13 wherein said leaf spring is fabricated from a strip of spring steel that is about 7 to 8 miles thick and about 0.3 inches wide, and wherein said mounting leg is about 0.6 inch in length, said intermediate leg is about 0.3 inch in length, and said terminal element is about 0.09 inch in length.

15. The cassette of claim 1 wherein said base component and said cover component are separate, mated components that are assembled with one another, and wherein at least one of said housing components provides said peripheral wall.

16. The cassette of claim 15 wherein said front wall of said cover component and said peripheral wall are integrally formed, as a single piece, with said peripheral wall extending generally perpendicular to said front wall.

17. The cassette of claim 1 wherein said means for supporting a roll of fresh printing ribbon comprises a supply spindle that is rotatably mounted upon said base component and that supports said roll of printing ribbon in fixed relationship thereto for unwinding during rotation of said supply spindle, and wherein said cassette additionally includes a drag arrangement constructed to exert a significant drag force upon said supply spindle for retarding rotation thereof.

18. The cassette of claim 1 wherein said cassette is constructed for operative assembly with a mailing machine, and wherein said printing ribbon is a thermal ink postage-printing ribbon.
